(19) United States
(12) Patent Application Publication
(10) Pub. No.: US 2010/0216095 A1
(43) Pub. Date: Aug. 26, 2010

(54) Method for Creating Shaded Dental Ceramic and Composition Created by Process

(76) Inventor: Chris Scharf, Golden, CO (US)

Correspondence Address: LARIVIERE, GRUBMAN & PAYNE, LLP, 19 UPPER RAGSDALE DRIVE, SUITE 200, MONTEREY, CA, 93940, US

(21) Appl. No.: 12/712,050

(22) Filed: Feb. 24, 2010

Related U.S. Application Data
(60) Provisional application No. 61/155,092, filed on Feb. 24, 2009.
(60) Provisional application No. 61/155,474, filed on Feb. 25, 2009.

(51) Int. Cl. A61C 13/083; B28B 1/00; C04B 35/48

(52) U.S. Cl. 433/212.1; 264/17; 501/134

(57) ABSTRACT

A method for creating shaded zirconium-oxide ceramics and a composition created by that method. Shaded yttrium tetragonal zirconium-oxide polycrystals are mixed to achieve a spectrum of final shaded ceramics matching the shades of human teeth. Ceramic material can be in raw form or can be milled and sintered as final product. A method for creating dental prosthetics and the dental prosthetics created by that method.

### PRIORITY CLAIM

This application claims priority to U.S. Provisional Patent Application No. 61/155,092, filed on Feb. 24, 2009 and to U.S. Provisional Patent Application No. 61/155,474, filed on Feb. 25, 2009.

### FIELD OF INVENTION AND INDUSTRIAL APPLICABILITY

This invention generally relates to zirconium-oxide based ceramics and the coloration of ceramics. More particularly, this invention relates to methods and materials used to match consistently the appearance of ceramic materials and ceramic dental prostheses to the natural shade of dental patients' teeth, specifically in relation to the Vita Shade Guide.

### BRIEF DESCRIPTION OF RELATED ART

Dental prostheses including crowns, bridges and dentures can and are often fabricated using zirconia-based ceramic materials. See for instance U.S. Pat. Nos. 6,165,925 to Rieger and 6,713,421 to Hauptmann, et al., each disclosing ceramic prosthetics composed of zirconium oxide stabilized with yttrium oxide. Zirconium-oxide based ceramics are well suited for use in dental prostheses due to their strength, toughness, and biocompatibility. However, the natural color of an unadulterated, sintered zirconium-oxide based prosthetic is too bright for use as a dental prosthetic without some supplemental shading to reduce the material's brightness and to emulate the varying shades of human teeth. Therefore, in order to achieve a more natural appearance, the prior art has developed several different methods and materials for shading zirconium-oxide based prosthetics. See, for instance, U.S. Pat. No. 6,709,694 to Suttor, et al. disclosing coloration of zirconia ceramic by dipping in ionic solution, and U.S. Patent Application Publication No. 2008/0085828 (Khan, et al.), disclosing coloration of zirconia ceramic by means of atmospheric exposure to coloring agents during the sintering process. However, the existing art methods and materials have a number of shortcomings, making them less than ideal solutions to the problem.

Prior art shading solutions involve dipping the prosthesis into, or otherwise applying to it, a liquid that acts as a stain on the surface of the zirconium-oxide based product. In contrast, an alternative method that results in a suitably shaded zirconium oxide product, and which also eliminates the need for a dipping or staining step in the manufacturing process, would be a more efficient, and therefore less expensive, solution—while also reducing manufacturing time.

Moreover, the coloring processes known in the art do not result in a consistent and uniform shade over time. Varying tolerances in the staining solution, varying exposure to the stain solution, diminishing effectiveness of the solution with use, and variation of technique in application are all factors that make the stain or dip process a solution that does not result in a uniform, consistent, predictable and reliable shading. When the end product is visible amidst the patient's actual teeth, the aesthetic concern associated with a reliable, precise shade replication is paramount.

Ideally, a shading solution should be capable of consistently and predictably replicating a standardized set of shades. One example of such a standardized system is the Vita Shade Guide. There is a need in the art for a reliable method that achieves a level of standardization and consistency that can be verified by comparison against a known standard.

Therefore, there is a need for a zirconium-oxide ceramic shading method that streamlines the manufacturing process and results in a predictable, uniform shading system which can be matched to the natural shade(s) of a dental patient's teeth.

### SUMMARY OF THE INVENTION

The present inventive concept solves the foregoing problem of shading zirconium-oxide based ceramics by incorporating a blend of shade constituents into the ceramic itself, such that no additional coloration step is necessary subsequent to the sintering of the material.

More specifically, Shades 0 through 7 of the Vita Shade Guide adequately represent useful points along the spectrum of natural, healthy tooth shades. The present inventive concept replicates these shades by precisely blending variously pigmented zirconium-oxide polycrystal mixtures. The final tooth-specific shade of the zirconia-based ceramic or milled prosthetic is achieved during the sintering process. Consequently, no additional coloration step is required. Moreover, by the instant inventive method, the coloring of the ceramic is uniform throughout the material rather than being limited to the surface as in prior art methods for staining zirconia-based ceramics and prosthetics.

### DETAILED DESCRIPTION OF THE INVENTION

In a first preferred embodiment of the instant inventive concept, a shaded zirconia-based ceramic block is fabricated. By precisely controlling the ratio of constituent materials, varying shades are created that match the tooth-like shades of the Vita Shade Guide. More specifically, Shades 0 through 7 of the Shade Guide are replicated by the specific, precise combinations of materials as set forth herein. In all embodiments, the constituent components mixed in the amounts set forth below allow for a uniformity of shade, depth and translucence in the final ceramic product.

A preferred embodiment of the invention may involve first creating separately shaded yttrium tetragonal zirconia polycrystal mixtures (YTZP) each having their own characteristic hue (herein referred to as brown, white, black and ivory), as listed below by mixing together appropriate mass percentages of YTZP with the following chemical components (selected from anhydrous iron-oxide [FeO(OH)], cobalt oxide [CoO], and erbium oxide [ErO]) or their functional equivalents for a period of time sufficient to achieve a substantially homogenous aggregate material. Under most circumstances, blending these constituent materials for 10 minutes is adequate to achieve the required homogeneity.

| | FeO(OH) | YTZP | CoO | ErO |
|---|---|---|---|---|
| Brown | 2% | 98% | | |
| White | | 100% | | |
| Black | | 95% | 5% | |
| Ivory | | 98% | | 2% |

Once pigmented mixtures of each YTZP powder are achieved, specific Vita shades and their corresponding mass percentage ratios of each pigmented YTZP powder are achieved as follows:

| | Brown | White | Black | Ivory |
|---|---|---|---|---|
| Shade | (%-age) | (%-age) | (%-age) | (&-age) |
| S0 | 0 | 99.93 | 0.07 | 0 |
| S1 | 2.50 | 97.38 | 0.16 | 0 |
| S2 | 4.99 | 94.85 | 0.16 | 0 |
| S3 | 7.98 | 91.86 | 0.16 | 0 |
| S4 | 2.48 | 96.89 | 0.62 | 0 |
| S5 | 4.96 | 94.18 | 0.86 | 0 |
| S6 | 2 | 88 | 10 | 0 |
| S7 | 4.25 | 85.75 | 0 | 10 |
| SP15 | 0 | 84.933 | 0.066 | 15 |

Once the aggregate material is adequately mixed, an amount of said material is placed into a mold and pressed under a pressure and for a time adequate to render a green form block. In one embodiment, biaxial pressure is applied to said aggregate material with a force in the range of 3500 to 6500 pounds per square inch, preferably approximately 5000 pounds per square inch, to create green form blocks. In a further embodiment, a second stage of pressure is applied, preferably iso-statically pressed with a force of in the range of 15,000 to 45,000 pounds per square inch, more preferably approximately 30,000 pounds per square inch, to achieve green form density. Subsequently, the blocks are dried at a temperature of about 120 C. for about two hours.

Once said blocks are formed, heat is applied. In a preferred embodiment, bisque firing said green form blocks is achieved by: (1) ramping to a temperature in the range of 600 to 800 C., preferably approximately 700 C., at a rate of approximately 80 C. per hour; (2) then holding for approximately two hours; (3) then ramping to a second temperature in the range of 850 to 1150 C., preferably, approximately 1000 C., at a rate of approximately 350 C. per hour; (4) then holding at approximately 1000 C. for approximately 2.1 hours; (5) then allowing to cool. This process results in shaded zirconium-oxide ceramic blocks that can be used as the base material for milling dental prosthetics or other relate, foreseeable applications.

In an alternative preferred embodiment of the instant inventive concept, a shaded zirconium-oxide prosthetic shape is fabricated, milled and sintered for use as a final product. The initial mixing and pressing steps are identical to the first preferred embodiment above, and the ratios corresponding to each shade are likewise identical.

In the alternative embodiment, once the ceramic blocks are pressed, they are cured at a maximum temperature in the range of 80 to 120 C., preferably approximately 100 C., by ramping to said maximum temperature at a rate of approximately 100 C. per hour, then maintaining said maximum temperature for approximately two hours, then allowing to cool.

Subsequently, the green form blocks are milled to create the desired prosthetic shape. Once milled, the final ceramic prosthetic is sintered by: (1) ramping to an initial temperature in the range of 600 to 800 C., preferably approximately 700 C., at a rate of approximately 80 C. per hour; (2) then holding at said initial temperature for a period of approximately 2 hours; (3) then ramping to a second temperature in the range of 1350 to 1600 C., preferably approximately 1490 C., at a rate of approximately 350 C. per hour; (4) then holding at said second temperature for 2.1 hours; (5) then ramping to a third temperature in the range of 1000 to 1200 C., preferably approximately 1100 C., and holding for a period of time adequate to achieve a fully sintered product; (6) then allowing to cool.

Information as herein shown and described in detail is fully capable of attaining the above-described object of the invention, the presently preferred embodiments of the invention, and is, thus, representative of the subject matter broadly contemplated by the present invention. The scope of the present invention fully encompasses all other embodiments which may become obvious to those skilled in the art, and is to be limited, accordingly, by nothing other than the appended claims, wherein reference to an element in the singular is not intended to mean “one and only one” unless explicitly so stated, but rather “one or more.” All structural, electrical, and functional equivalents to the elements of the above-described preferred embodiment and additional embodiments that are known to those of ordinary skill in the art are expressly incorporated herein by reference and are intended to be encompassed by the present claims.

Moreover, it is not necessary for a device or method to address each and every problem sought to be solved by the present invention for it to be encompassed by the present claims. Furthermore, no element, component or method step in the present disclosure is intended to be dedicated to the public regardless of whether the element, component, or method step is explicitly recited in the claims. No claim element herein is to be construed under the provisions of 35 U.S. C. 112, sixth paragraph, unless the element is expressly recited using the phrase “means for.”

We claim:

1. A method for creating a shaded ceramic including the steps of:
Creating three uniquely shaded yttrium tetragonal zirconia polycrystal pigment mixtures, each having their own characteristic hue, by mixing together YTZP powder with a chemical component selected from the group of anhydrous iron-oxide [FeO(OH)], cobalt oxide [CoO], and erbium oxide [ErO]);
Mixing together unpigmented YTZP powder with one or more of said pigment mixtures to achieve a predetermined shade;
Placing said mixture of predetermined shade into a mold and applying pressure for a time adequate to render a green form block;
Drying said green form block;
Bisque firing said green form block.

2. A method for creating a dental ceramic comprising the method of claim 1, with the further steps of milling the block to create a desired form, and sintering said form.

3. The method of claim 1 wherein the three shaded pigment mixtures comprise the following component percentages by mass:

| | FeO(OH) | YTZP | CoO | ErO |
|---|---|---|---|---|
| Brown | 2% | 98% | | |
| White | | 100% | | |
| Black | | 95% | 5% | |
| Ivory | | 98% | | 2% |

4. The method of claim 1 wherein the predetermined shade is given by any one of the following shaded pigment mixtures on a mass percentage basis:

| | Brown | White | Black | Ivory |
|---|---|---|---|---|
| Shade | (%-age) | (%-age) | (%-age) | (&-age) |
| S0 | 0 | 99.93 | 0.07 | 0 |
| S1 | 2.50 | 97.38 | 0.16 | 0 |
| S2 | 4.99 | 94.85 | 0.16 | 0 |
| S3 | 7.98 | 91.86 | 0.16 | 0 |
| S4 | 2.48 | 96.89 | 0.62 | 0 |
| S5 | 4.96 | 94.18 | 0.86 | 0 |
| S6 | 2 | 88 | 10 | 0 |
| S7 | 4.25 | 85.75 | 0 | 10 |
| SP15 | 0 | 84.933 | 0.066 | 15 |

5. A shaded ceramic created by the method set forth in claim 1.

6. A dental ceramic prosthesis created by the method set forth in claim 1.

7. A shaded ceramic created by the method set forth in claim 4.

8. A dental ceramic prosthesis created by the method set forth in claim 4.
